(19) United States
(12) Patent Application Publication
(10) Pub. No.: US 2014/0056001 A1
(43) Pub. Date: Feb. 27, 2014

(54) LED LIGHT BULB MODULE

(71) Applicants: LU-CHEN HSU, TAIPEI CITY (TW); CHE-MIN KUNG, TAIPEI CITY (TW); RA MIN TAIN, NEW TAIPEI CITY (TW)

(72) Inventors: LU-CHEN HSU, TAIPEI CITY (TW); CHE-MIN KUNG, TAIPEI CITY (TW); RA MIN TAIN, NEW TAIPEI CITY (TW)

(73) Assignee: INDUSTRIAL TECHNOLOGY RESEARCH INSTITUTE, HSINCHU (TW)

(21) Appl. No.: 13/594,077

(22) Filed: Aug. 24, 2012

(51) Int. Cl. F21V 21/00; F21V 29/00

(52) U.S. Cl. 362/249.02

(57) ABSTRACT

A light emitting diode (LED) light bulb module includes an LED light bulb unit having a first connector; an LED supporting device unit having a second connector which is configured to electrically coupled to the first connector, and a third connector which is configured to electrically coupled to a power supply source; and a thermal insulating structure configured to thermally decouple the LED light bulb unit and the LED supporting device unit. The LED light bulb unit and the LED supporting device unit can be either physically joined or detached from each other, and ideally, two separated heat sink apparatuses, each dedicated to the LED light bulb unit and the LED supporting device unit, respectively may be used.

### TECHNICAL FIELD

The present disclosure relates to a light emitting diode (LED) light bulb module, and more particularly, to an LED light bulb module for lighting applications.

### BACKGROUND

Light bulbs for lighting application may be divided into two main categories; incandescent light bulbs and luminescent light bulbs. The luminescent light bulbs include low or high pressure gaseous discharge lamps, wherein the low-pressure gaseous discharge sources are the fluorescent and sodium lamps. On the other hand, the high-pressure gaseous discharge sources are mercury-vapor, metal halide and high-pressure sodium lamps. In general, the lifetime of these lamps is far shorter than that of LED light bulb modules.

Different lighting apparatuses result in different lifetimes. For example, a conventional tungsten light bulb averagely lasts about 1,000 hours; a power saving light bulb lasts about 10,000 hours; a T5 tube lasts about 15,000 hours; and an LED light bulb without concerning the lifespan of its devices and/or the corresponding integrated circuits may last about 100,000 hours.

Most of the existing power-saving light bulbs must carry some necessary devices and high-power integrated circuits to perform different tasks and functions, including power (or I/V) conversion from AC to DC, power-saving, power-management, and meeting safety regulations. These circuits and devices, also called “supporting devices”, which also comprise different sizes of capacitors, inductors, resistors, and high-power integrated circuits with semiconductor transistors. Unlike any conventional integrated circuits, the integrated circuits and devices within the supporting device area must sustain a higher voltage and current load compared to conventional IC; this is why such integrated circuits are also called “Power IC”.

Generally speaking, an LED light bulb module is composed of an LED light source portion with at least one LED device and a supporting device portion. Comparatively, the supporting device (including capacitors, resistors and inductors used for power IC) suffers a shorter lifetime than its LED light source counterparts, especially when operating under an environment of inefficient heat dissipation.

Low-cost, high-capacity electrolytic capacitors are a typical choice for LED supporting devices. The electrolyte (or an ionic conducting liquid) is used as one of the two electrode plates to achieve a larger specific capacitance than any other types of capacitors. Under the normal condition, the lifetime of an electrolytic capacitor lasts for 20,000 hours. However, it has been reported that such a lifetime decreases approximately by half for every 10 degrees Celsius of temperature increase.

For any light bulb module sold today, mostly its light source as well as the supporting devices are integrated together to form one single unit. Such a single unit design makes perfect sense for all kinds of lighting devices if the light source of these lighting devices offers a similar lifetime as its supporting device counterpart. In other words, when the efficiency of the light source starts to degrade, the supporting device itself also reaches a point for replacement. Therefore, the light source and the supporting device should be integrated into one unit for economical purposes.

On the other hand, the LED device itself lasts about 5 times longer than the corresponding supporting devices. For example, the power consumption from the LED portion of a normal “high-power” LED light bulb is about 9 W. Assuming that energy conversion efficiency is about 20%, the heat generated by the light bulb is about 7.2 W. On the other hand, the power consumption of the corresponding supporting devices is about 1 W, and the heat generates at most 1 W. When the LED light source and its supporting device are integrated and sharing one single heat sink, the temperature of power IC within the supporting devices will be raised quickly and start to break down. When the supporting devices fail, the whole lighting module must be discarded. This is why the lifespan of an LED light bulb module is determined mainly by that of the supporting devices, or more specifically by the circuits formed by passive devices.

In the past, one solution to solve this problem was to make the component of the supporting devices replaceable. That is, when the LED light bulb module fails, one must first take apart the module and determine which component of the supporting devices has been worn out. Once the failed component is identified, a replacement of that component shall follow. This solution is not pragmatic because it requires special talent, knowledge, labor and tools to perform the task.

Another proposed solution was to place the light source and the supporting device units on a thermally conductive substrate. The goal is to dissipate the heat generated from both the LED light source and the supporting devices more efficiently via a joint heat sink. The reality is that the heat generated by the light source cannot be quickly removed by the heat sink before it destroys the supporting devices. It was known that the capacitor devices are vulnerable to heat generated by the LED light bulb module.

There are two kinds of LED light bulbs, the first kind is called a DC (or Direct Current) LED, and the second kind is called an AC (Alternative Current) LED. The DC LED operates under DC current in which the conventional AC supply must first be converted into DC. The AC LED can directly use the AC power and thus does not require the supporting devices to serve the purpose of AC/DC conversion. Although the DC LED takes up more hardware to convert the power supply, it appears to be much more power-efficient and thus has become the mainstream in the LED light bulb market.

The LED light source per se generates significant amounts of heat, and due to the closed packaging environment, a failure to effectively dissipate heat causing a temperature rise on the supporting devices. As the result, the components of the supporting devices start to breakdown prematurely. Due to this reason, the lifetime of the LED light bulb module becomes much shorter than that of LED light source.

### SUMMARY

An embodiment of the disclosure is to design a light emitting diode (LED) light bulb module including at least one LED light bulb unit and at least one LED light bulb supporting device unit (hereinafter “LED supporting device unit”). At least one thermal insulating portion is configured to at least partially thermally decouple the LED light bulb unit and the LED supporting device unit.

Another embodiment of the disclosure is to design a LED supporting device unit including a body portion, a heat dissipation structure, a first connector and a second connector. The body portion comprises at least one LED supporting device and is thermally coupled to the heat dissipation structure. The first connector allows the at least one LED supporting device to be electrically coupled to an external LED light bulb unit, and the second connector allows the at least one LED supporting device to be electrically coupled to an external power supply.

Another embodiment of the disclosure is to design a LED light bulb unit including a light bulb body having a cap, at least one base plane and a plurality of LED devices, a connector, and a heat dissipation structure. The plurality of LED devices are coupled to at least one base plane of the light bulb body inside the cap and electrically coupled to an external LED light supporting device unit through the connector. The heat dissipation structure is thermally coupled to the light bulb body to dissipate heat generated by the LED devices

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention are illustrated with the following description and upon reference to the accompanying drawings in which:

FIG. 1 depicts an LED light bulb module according to one embodiment of the present disclosure;

FIG. 2 depicts a cross-sectional view of an LED light bulb unit according to one embodiment of the present disclosure;

FIGS. 3A and 3B depict cross-sectional views of LED supporting device units according to some embodiments of the present disclosure;

FIGS. 4A to 4D illustrate dimensions of the heat dissipation structures of the LED supporting device unit and the LED light bulb unit, respectively;

FIG. 5 depicts a cross-sectional view of an LED module according to another embodiment of the present disclosure;

FIG. 6 shows a circuit diagram of an LED supporting device unit according to one embodiment of the present disclosure;

FIG. 7 shows a circuit diagram of an LED supporting device unit according to another embodiment of the present disclosure;

FIG. 8 shows a circuit diagram of an AC/DC rectifier according to one embodiment of the present disclosure;

FIG. 9 shows a simplified circuit diagram of an AC/DC rectifier according to one embodiment of the present disclosure;

FIG. 10 shows interconnections between two circuit blocks according to one embodiment of the present disclosure;

FIGS. 11A to 11C show an integration of the active and the passive components in the supporting devices according to three embodiments of the present disclosure;

FIG. 12 shows a cross-sectional view of an LED supporting device unit including a pluggable component for active components and a pluggable component for passive components according to one embodiment of the present disclosure;

FIGS. 13A to 13C illustrate a pulse-width modulation circuit in the LED supporting device unit and the corresponding waveform diagram of said modulation circuit, respectively, according to one embodiment of the present disclosure;

FIG. 14 illustrates a constant current circuit in the LED supporting device unit according to one embodiment of the present disclosure; and

FIG. 15 illustrates a switch circuit block diagram in the LED supporting device unit which is used to determine the AC/DC mode according to one embodiment of the present disclosure.

### DETAILED DESCRIPTION OF DISCLOSED EMBODIMENTS

In order to extend the lifetime of an LED module, one embodiment of the present disclosure provides an LED light bulb module design having an LED light bulb unit and a corresponding supporting device unit. Both units are configured to be thermally separated from each other. In such a way, the heat generated from the LED light bulb unit is unable to damage the supporting device unit, thus the lifetime of the entire LED module can be prolonged. When either unit fails, one can just replace the malfunctioned unit with a functioning one.

Another embodiment is to implement two independent heat-dissipation structures respectively to the two heat-generating units (i.e. LED light bulb unit and LED supporting device unit). Therefore, heat generated from both units can be dissipated more efficiently, while the thermal cross-contamination problem is eliminated. The heat generated from the LED light bulb unit cannot shorten the lifetime of the LED supporting device unit.

The independent LED light bulb unit comprises an LED light bulb body having at least one LED device, a bulb cap, and a heat sink dedicated mainly to dissipate the heat generated by the LED light bulb unit. The independent LED supporting device unit comprises all the required LED power IC circuits, including active devices, such as power converters (i.e. AC/DC, DC/DC converters); and passive devices, such as capacitors, resistors, and/or transistors, etc. The LED supporting device unit has its own designated heat sink which is designed to dissipate the heat solely generated from the LED supporting device unit. The goal of such a design is to allow the LED supporting device unit to be electrically coupled, but thermally decoupled from the LED light bulb unit.

Another embodiment of the present disclosure is to place a thermal insulator between these two units and thus allow the two heat-sinks to function independently. The design of such a heat sink for each unit becomes much more straightforward since the thermal interference between the two units no longer exists. The heat sink devices can be horizontal or vertical fin-type or any other types to increase the surface area for better cooling efficiency. In this case, the two units can be either physically separated or jointed together.

One more embodiment of the present disclosure provides an active circuit block composed of active components (such as transistors) and a passive circuit block composed of passive components (such as capacitors, inductors, resistors, etc.) in the LED supporting device unit. Separation of the active and passive components makes supporting device units easier to repair. When the passive component fails, it may be replaced while keeping the rest of the module intact. It is known that discrete devices, especially low-cost electrolytic capacitors tend to fail with numerous mechanisms. Of course, a more expensive alternative such as film capacitors can be used to solve the problem, but for any capacitor with a capacitance in mille-farad ranges required by LED supporting device design, defect density, thermal effect, and voltage stress are major causes of failure. The present embodiment includes at least one pluggable circuit card, similar to that of a USB, containing passive or active components. The card(s) can be inserted into the supporting device unit to perform supporting device functions. When any of the cards fails, one can easily replace it with a new one. This design makes the replacement of faulty parts much easier.

One more embodiment of the present disclosure is to provide an LED supporting device unit with various features and functions, including power dimming, power surge protection and remote control. The light intensity of the LED light bulb unit can be controlled by, for example, an on-wall switch unit as well as a remote controller. The power surge protection device provides the LED light-bulb module with hot-plug capability. For example, an LED light bulb unit can be mounted to the module while a power supply is attached.

One more embodiment of the present disclosure is to accommodate the LED supporting device unit with AC and DC LED light bulb units. The supporting device unit can supply AC power when an AC LED light bulb unit is installed or DC power when a DC LED light bulb unit is installed. User may switch the LED supporting device unit from DC to AC mode (and vice versa) before or after the mounting the AC or DC LED light bulb module.

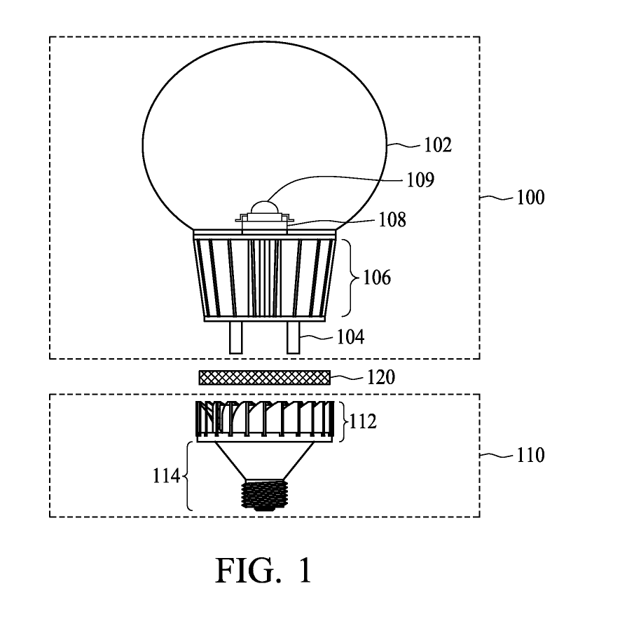

As shown in FIG. 1, an LED light bulb module according to one embodiment of the present disclosure includes an LED light bulb unit 100, an LED supporting device unit 110 (for simplicity, hereon called supporting device unit), and a thermal insulating portion 120. The thermal insulating portion can be made of thermal insulating materials, including a structure to hold air space. The LED light bulb unit 100 has, not in a limited way, a cap 102, a base plate 108 where at least one LED device 109 is positioned, and a first (e.g., male) connector 104; wherein the base plate 108 is thermally engaged to a heat sink 106. The LED supporting device unit 110 has, not in a limited way, a heat sink 112 coupled to a body portion. Within the body portion, a second (e.g., female) connector (not shown), integrated circuits (ICs) and devices and a third connector 114 are provided. The second connector is used to electrically couple to the first connector of the LED light bulb unit. The third connector is designed to fit into any conventional socket to receive a power supply. It is understandable that the arrangement of LED devices can be deviated from current design. It can be arranged in DC or AC connection modes.

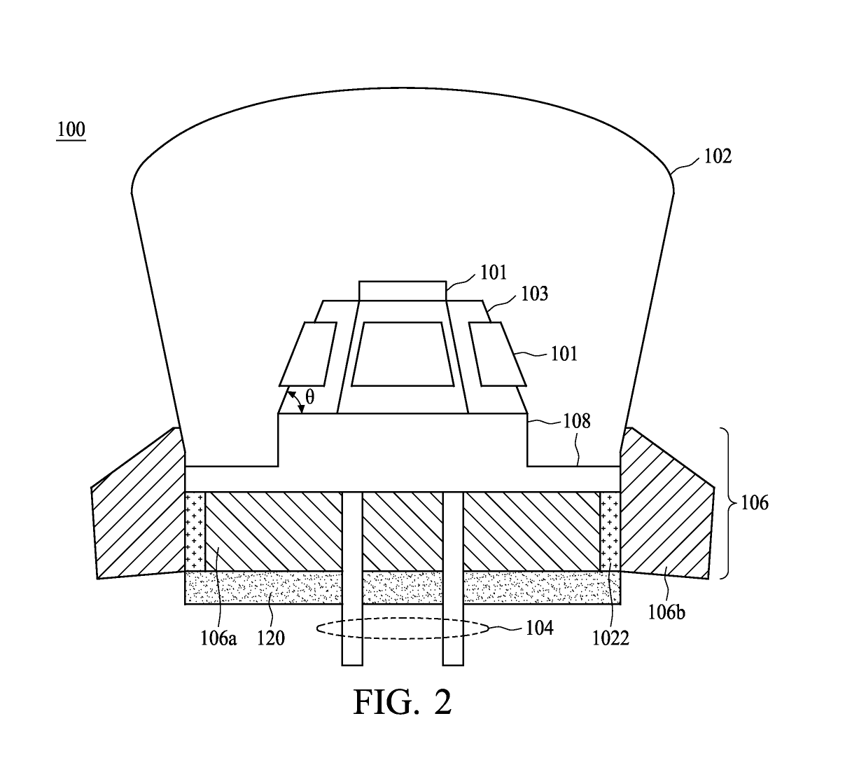

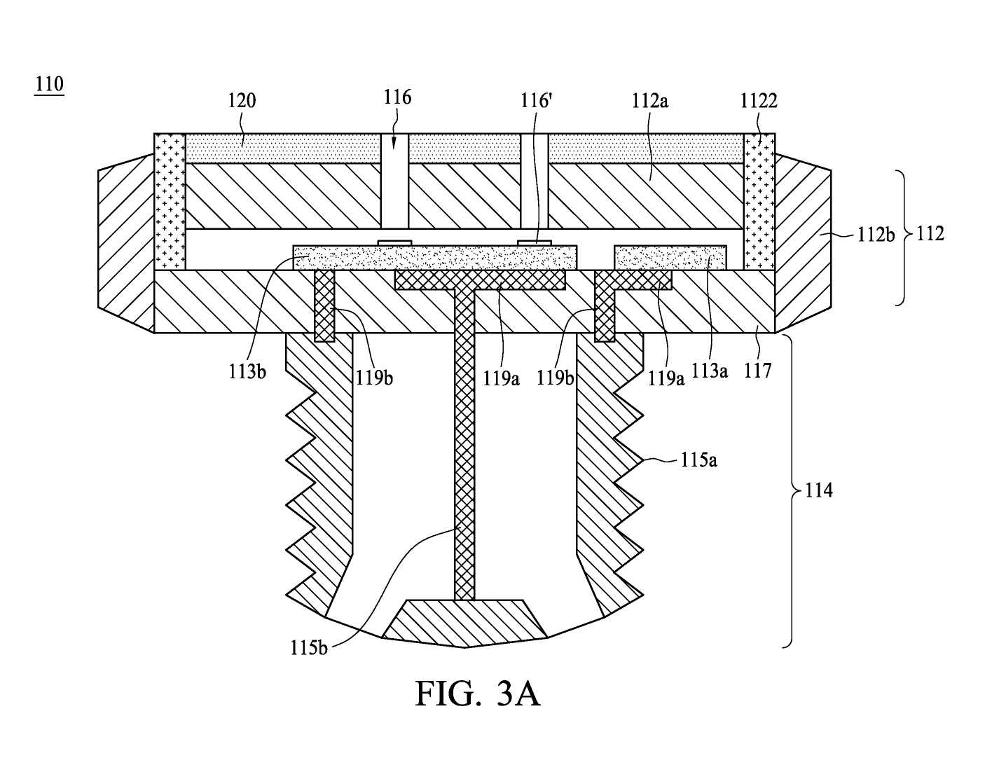

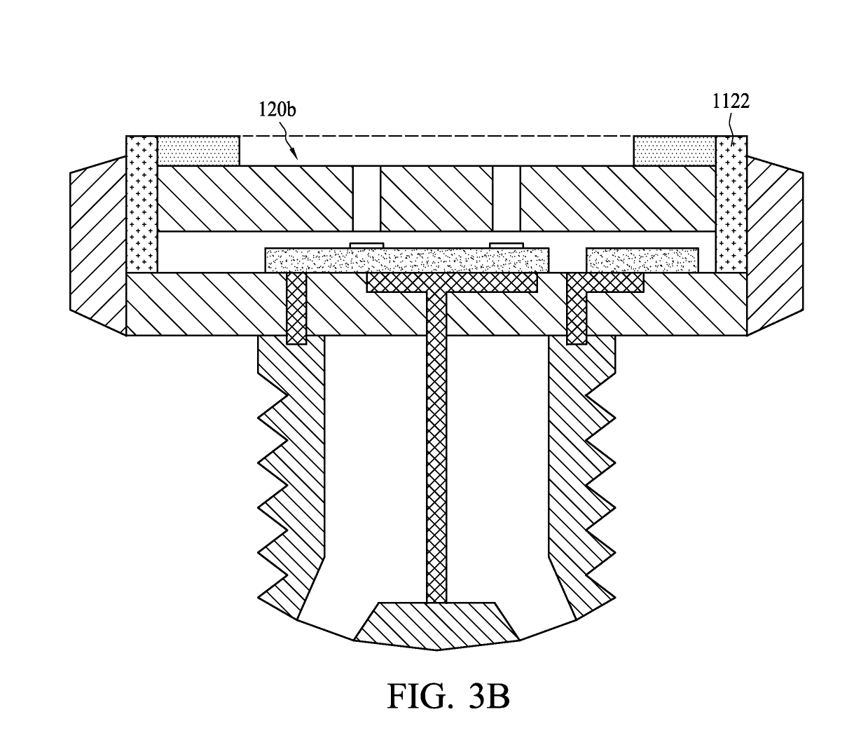

As shown in FIG. 2, an enlarged illustration of the LED light bulb unit 100 is depicted in detail. In this embodiment, a plurality of LED devices 101 are mounted on a stand 103, and the stand 103 has a base plate 108 that is thermally coupled to a heat sink 106. The heat sink includes, in the present embodiment, a plane portion 106a and a plurality of fin portions 106b. A core ring portion 1022 is disposed at the circumference of the plane portion 106a of the heat sink. The plane portion 106a is directly positioned and thermally in contact with the base plate 108 and the stand 103 of the LED devices 101, whereas the plurality of fin portions 106b are attached to the plane portion 106a and laterally extended to increase the surface area to facilitate heat dissipation. Although a fin is the preferred option, any other shapes of heat sink design which effectively increase surface area thereof can also be used. A pair of male connectors 104 extends out from the base plate 108 to be electrically connected to an LED supporting device unit (see FIGS. 3A and 3B), in order to connect to a power supply. In the present embodiment, a pin-type connector is depicted in FIG. 2. However, in another embodiment, a screw-type connector or connectors of other forms may also be used in substituting the pin-type connector as long as it provides two leads which electrically connect to the two poles of the LED devices 101. The LED light bulb unit 100 as shown in FIG. 2 can be optionally equipped with a thermal insulating portion 120 located at the bottom of the LED light bulb unit 100 and is configured to thermally decouple the LED light bulb unit 100 from the LED supporting device unit 110. The thermal insulating portion 120 may or may not be assembled to the LED light bulb unit 100. Since the purpose of having this thermal insulating portion 120 is to form a heat conduction barrier between these two units (LED light bulb unit 100 and supporting device unit 110), the thermal insulating portion 120 or thermal insulating layer may either be integrated on the LED light bulb unit 100 or the LED supporting device unit 110. In another embodiment, said two units are both equipped with the thermal insulating portion 120. Conversely, both units may not be provided with such a thermal insulating layer, but users could insert said thermal insulating portion when using the module. It is understandable that a thermal insulating portion 120 can also be a structure designed on either LED light bulb unit or LED supporting device unit, or both, that provides an air space. Details will be illustrated in a following paragraph.

FIG. 3A shows an enlarged illustration of the LED supporting device unit 110. It comprises a body portion 112, a heat sink structure (112a, 112b), a second connector 116 and a third connector 114. A pair of corresponding female connectors 116 is provided to fit the above-mentioned male connector of the LED light bulb unit 100. A heat sink that is thermally coupled to the body portion 112, including a plane portion 112a and a plurality of fin portions 112b, is placed on a base plate 117. A core ring portion 1122 is disposed on the base plate 117, on the circumference of the plane portion 112a of the heat sink. The shape of the heat sink is not limited to the fin; it can be any other shape to obtain a similar surface area for heat dissipation. Inside the body portion, the female connector 116 penetrates through the thermal insulating portion 120 and the plane portion 112a of the heat sink 112. It allows the male connect of LED light bulb unit 100 to electrically be connected to internal power supply contacts 116′ which are located on the surface or adjacent to at least one of the supporting devices (or chips) 113b. Such internal power supply contacts are output power supply pads from supporting devices (or chips) of the LED supporting device unit.

It is understandable, that a thermally conductive plane portion 112a can also be placed underneath the power IC devices, or can be at least a portion of the base plate 117 to enhance the thermal conductivity. In this example, the power supply of the supporting devices 113a and 113b are connected to two electrodes of a third connector 114 through interconnecting means, such as wire bonding, or through a silicon via (not shown) and reaches to power supply wirings 119a, 119b located on the base plate 117. A first electrode 115a and a second electrode 115b make up the third connector 114 that is configured to fit into a light bulb socket (not shown). The third connector shown in this embodiment is of a screw type connector, but the present disclosure does not limit the shape of the third connector to be a specific form, a pin-type connector or any other types of connector also within the scope of present disclosure. The third connector allows the power supply from the outside world to reach to the power input nodes of the supporting devices (or chips). At least one of the supporting devices 113a and 113b located on the base plate 117 may contain discrete devices, and the two supporting device blocks (or chips) are electrically interconnected to each other. In the present embodiment, the thermal insulating portion 120 is shown to be on top of the LED supporting device unit 110, but the insulating portion 120 may or may not be integrated with the LED supporting device unit 110. The placement option of the insulating portion 120 herein is the same as that described in the previous paragraph.

Optionally, air spaces in between the plane portion 112a of the heat sink 112 and base plate 117 can be filled with thermally conductive material such as aluminum oxide to further enhance heat dissipation of supporting devices to the heat sink.

As shown in FIG. 3B, another embodiment is to have an air-space structure 120b formed on top of the LED supporting device unit, such that when the LED light bulb unit is mounted on top of the supporting device unit, the air space structure 120b can be used for thermal isolation between these two units.

According to the description above, the two units (LED light bulb unit 100 and supporting device unit 110) are physically detachable and therefore can be manufactured separately. End users of the LED module may obtain each unit from the same or from different providers. It is possible that the thermal insulating portion 120 can be obtained from the same suppliers mentioned above or an independent supplier.

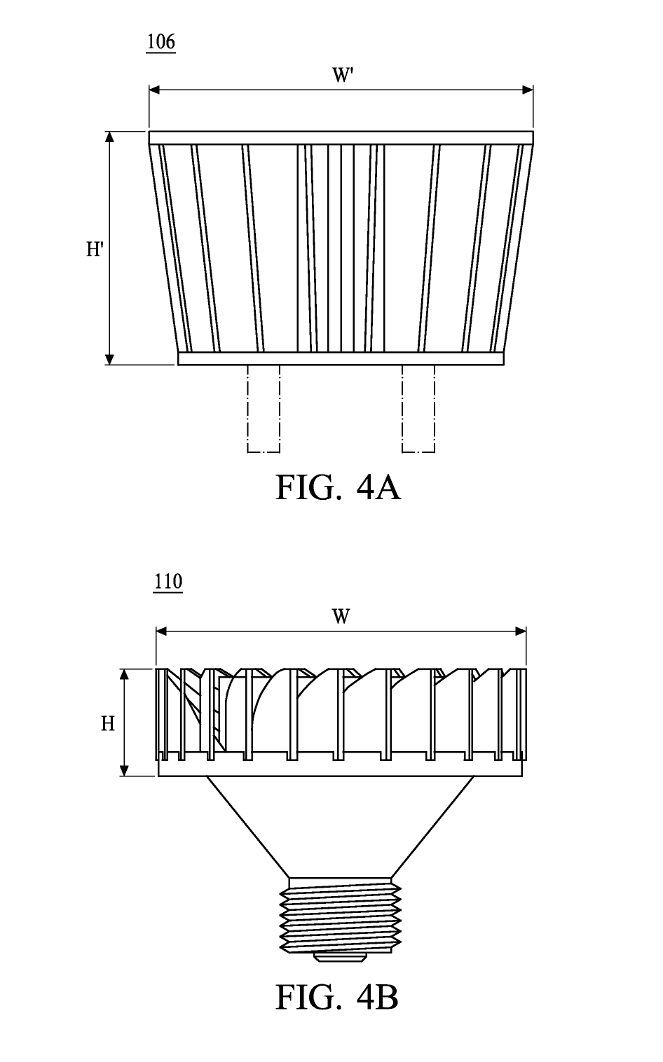

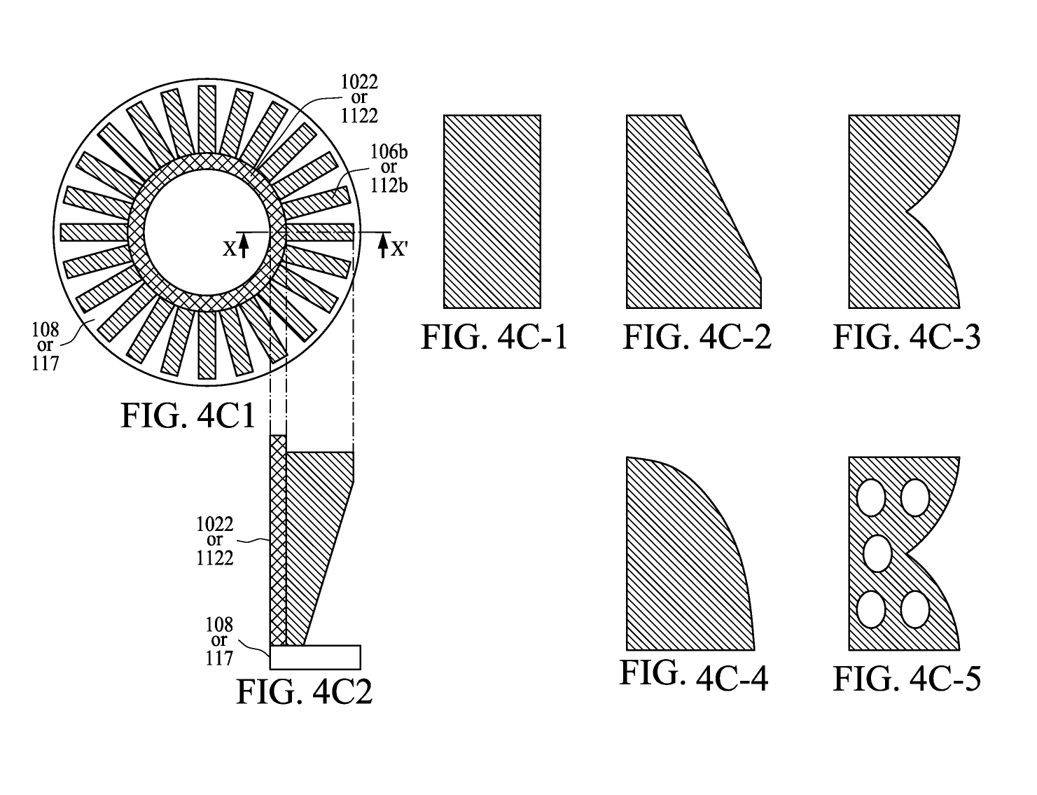

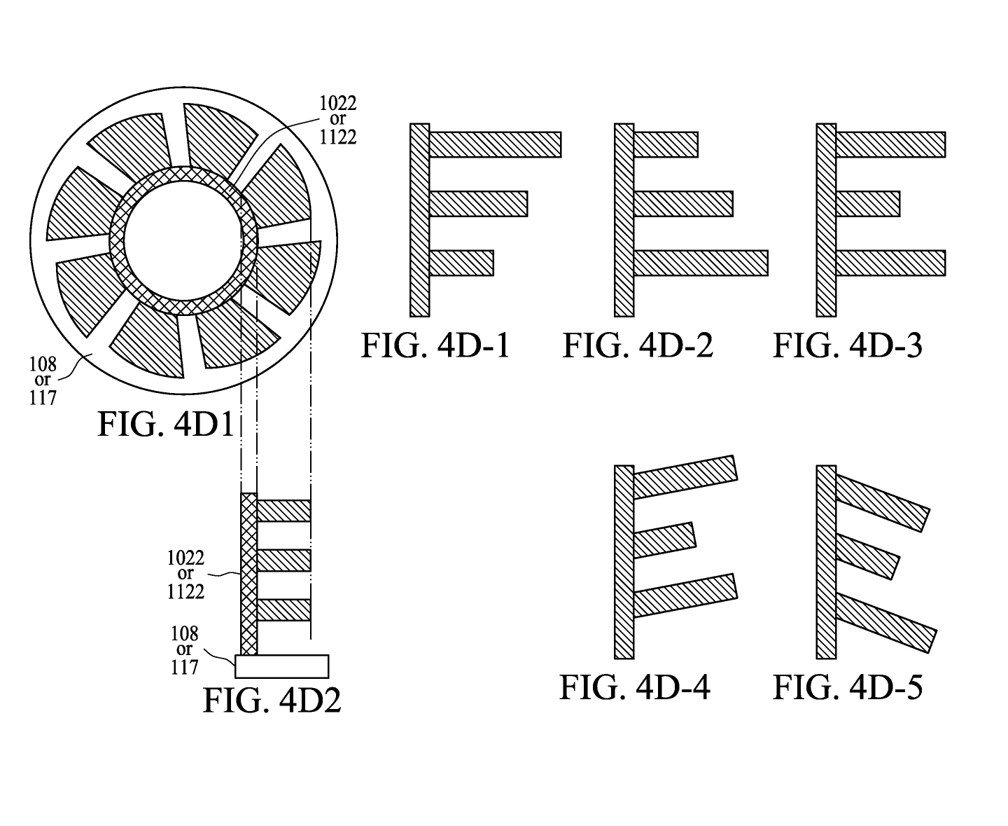

FIGS. 4A and 4B illustrate possible dimensions and the shapes of the heat dissipation structure (or heat sink) of the LED light bulb unit 100 and that of the LED supporting device unit 110, respectively. A standard LED light bulb generates about 8 W of power. In one embodiment of the present disclosure, the LED light bulb unit requires a heat sink 106 having a diameter (W′) of about 6 cm and a height (H′) of about 4.5 cm as shown in FIG. 4A. In one embodiment, the heat sink of LED light bulb unit 100 may include 24 fins and provides a circumferential heat dissipation surface area of 324 cm². The aforesaid design is devised under the assumption that heat generated from the LED device shall be dissipated mainly by the heat sink 106 of the LED light bulb unit 100. In addition, the thermal insulating portion 120 (see FIG. 1) shall substantially block the thermal conduction path to the supporting device unit 110, the surface temperature of the LED light bulb unit's heat sink may reach about 50 degrees Celsius, and LED junction temperature may keep at about 65 degrees Celsius. Within the current design, the LED junction temperature can be much lower, granting better energy conversion efficiency and resulting in a longer lifetime of the LED device.

In another embodiment, for example an 8 W LED light bulb, heat dissipated from the supporting device unit 110 is estimated to be less than or close to 1 W; therefore a smaller heat sink is required by the supporting device unit 110 than that for the LED light bulb unit 100. By stating a smaller heat sink for the LED supporting device unit 110, an exemplary implementation in one embodiment of the present design is having a diameter (W) of about 4 cm and a height (H) of about 1 cm as shown in FIG. 4B. The heat sink example includes 24 fins with a radial length of 1 cm and provides a circumferential heat dissipation surface area of 48 cm². Such a design is based on an assumption that most of the heat generated by the LED light bulb unit 100 is dissipated not by the heat sink of the LED supporting device unit 110, but by the heat sink of LED light bulb unit 100. Within the current design, the surface temperature of the heat sink of the supporting device can be kept at about 50 degrees Celsius, and the junction temperature of the LED supporting devices or power IC devices 113a and 113b shown in FIG. 3A can be kept at about 65 degrees Celsius. Under such circumstances, the lifetime of power IC devices (or chips) 113a and 113b will be longer than the conventional LED light bulb having a single heat sink which is shared by the LED light bulb and its supporting devices. In estimation, the junction temperature of the power IC devices 113a and 113b within the current design can be dropped by 20 degrees Celsius compared to that of the conventional design. Subsequently, the lifetime of power IC devices and thus the supporting device unit within the current design is projected to be extended from 2 to 8 years.

FIG. 4C1 and 4C2 show the top and cross-sectional views, respectively, of an exemplary heat sink design for both the light bulb unit and the supporting device unit. The first type of heat sink proposed here can be categorized as the vertical-arranged heat sink. The top view shows a plurality of fins (106b or 112b, referring to FIGS. 2 and 3) that are vertically arranged in the radial direction. A portion of one side of the fin edge can be attached to a core ring portion (1022 or 1122, referring to FIGS. 2 and 3), while the other portion of said one side or the other side of the fin can be attached to a base plate (108 or 117). The shape of the fin comprises any shape shown in FIG. 4C-1 to FIG. 4C-5, or the combination of the above. It is also understandable that any other shapes not illustrated are not excluded from this invention.

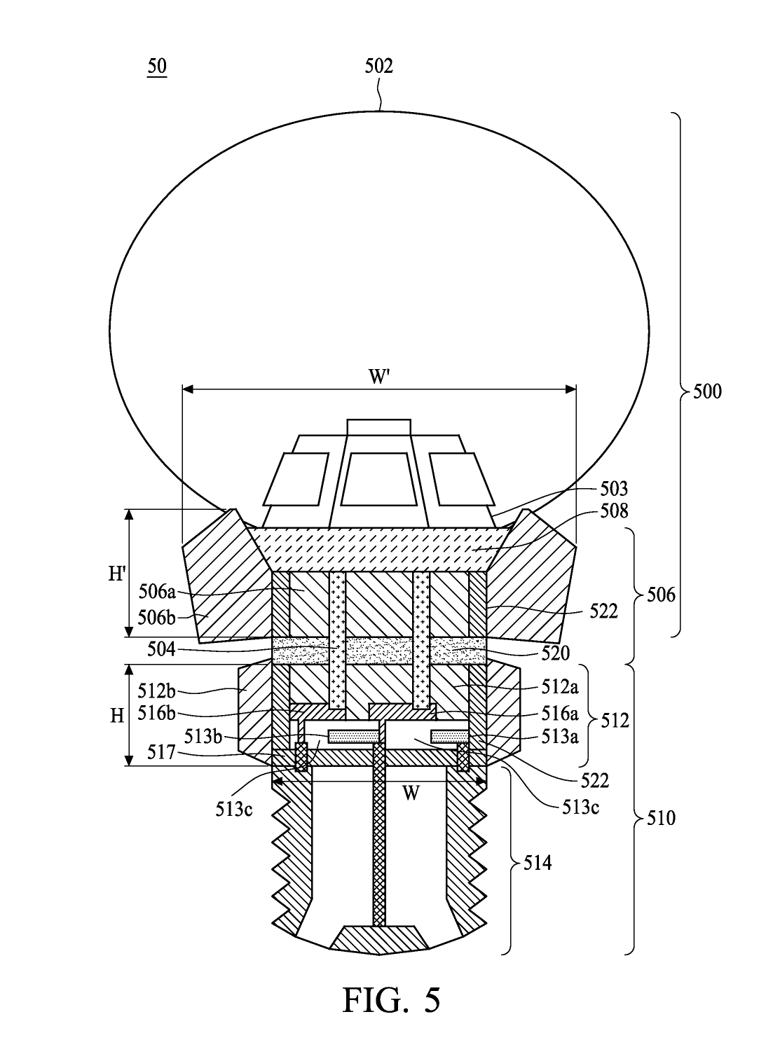

The second type of heat-sink proposed here can be categorized as the horizontal-arranged heat sink. The top view (see FIG. 4D1) shows a plurality of fins (106b or 112b) that are horizontally arranged in the radial direction. FIG. 4D2 shows the cross-sectional view of an exemplary horizontal-fin heat sink. One side of the fin edge can be attached to a core ring portion (1022 or 1122, referring to FIGS. 2 and 3). The shapes and the sizes of the fin can be varied, as shown in FIG. 4D-1 to FIG. 4D-3, or the combination of the above. It is also understandable that fins can also be deviated from horizontal directions such as those illustrated in FIG. 4D-4 and 4D-5, and any other shapes not illustrated here are not excluded from this invention.

FIG. 5 shows the cross section of an LED light bulb module 50 in one of the embodiments including an LED light bulb unit 500 and a supporting device unit 510. A thermal insulating portion 520 is placed between these two units to prevent the module from thermal cross-contamination. The LED module of these two units can be either physically detachable, as described in the previous embodiments, or physically fabricated into one piece. When the two units (the LED light bulb unit and the supporting device unit) are thermally isolated and each unit has its own heat sink (506, 512), the lifetime of the supporting devices 513a and 513b become very close to the lifetime of LED light bulb unit (8 years vs. 10 years); therefore, when supporting devices start to degrade, the user may replace the entire single piece device. In the present embodiment, a core ring portion 522 is positioned at the circumference of the plane portion (506a, 512a of each heat sink), and the thermal insulating portion 520 or structure can be placed in between two units (500 and 510). Inside the supporting unit 512, an air space 531c is allowed.

In one embodiment of the present disclosure, the thermal insulating portion may compose of plastic materials such as polyurethane, which has a thermal conductivity in the range of 0.012 to 0.013 W/(mK), or two times lower than air. Other materials having low thermal conductivity such as, not in a limited way, polypropylene, can also be used. In terms of a detachable device, the insulating layer 520 can be packaged with the LED light bulb unit 500, the LED supporting device unit 510, or both. The insulating layer 520 can also be a free standing consumable items provided by another supplier.

Thermal insulating materials described below can also be considered as options for the thermal insulating portion 520. For example, Aerogels, used by NASA for the construction of heat resistant tiles, capable of withstanding heat up to approximately 2000 degrees Fahrenheit with little or no heat transfer; microporous silica and ceramic fiber have been used in high temperature environment between 200 and 2000 degrees Celsius; Zirconia fibers have the lowest thermal conductivity of all ceramic fiber and have been used up to 2000 Celsius.

In FIG. 5, the dimensions of the heat sink 506 of the LED light bulb unit 500 in the present embodiment may be, for example, about 6 cm in diameter (W′) and about 4.5 cm in height (H′) with a minimum circumferential heat dissipation area of 60 cm². It can be used to dissipate a total 8 W of heat generated from the LED light bulb unit 500; whereas the dimensions of the heat sink 512 of the supporting device unit 510 may be about 4 cm in diameter (W) and about 1 cm in height (H) with a minimum circumferential heat dissipation surface area of 8 cm², provided that 1 W of heat is produced by the LED power circuit 513a and the passive devices 513b. The dimensions of heat sinks mentioned above are for a preferred mode. Any other proper sized heat sink designs, shape, orientation, size or with a reasonable material are not excluded from the spirit of the disclosure.

In one embodiment, the two units (the LED light bulb unit and the supporting device unit) are integrated to become a free standing (or single piece) module. As shown in FIG. 5, the connectors 504 forming electrical connection between the LED light bulb unit 500 and the supporting device unit 510 penetrates through plane portions of two heat sinks (506, 512) as well as the thermal insulating portion 520. The connectors 504 first reach to the power contact pads 516a and 516b, which are coupled to the supporting devices 513a and 513b (or Power IC chips). The power supply to the power IC devices is obtained from two electrodes from an external connector 514, which fits into a light bulb socket (not shown). The shape of the connectors 504 in this example are that of a pin-type and the external connector 514 is that of a screw-type; however, such shapes can be replaced or substituted by any other shapes.

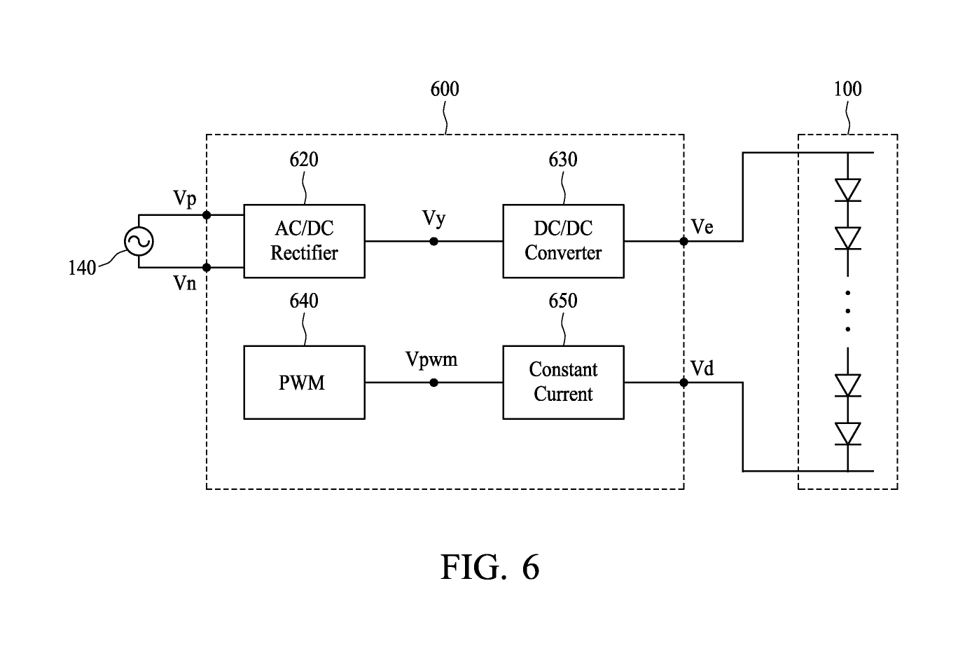

The supporting device unit mentioned above comprises some circuits formed by active and/or passive devices. The circuit of a supporting device as shown in FIG. 6 has an AC/DC rectifier 620 coupled to an external AC supply 140 via node Vₚ and Vₙ, and therefore, DC power is generated at node V_{y}, which is provided to the LED light bulb unit 100. In one embodiment, the supporting device circuit may also include additional circuits configured to optimize power efficiency. In another example, the DC power supply is fed into a DC/DC converter 630 to reduce the voltage level from not more than 350V to a proper DC level, for example about 48V, at node Vₑ. A bulk converter may, not in a limited way, be used as the DC/DC step-down converter. To protect the LED light bulb unit 100 from sudden power surges, a constant current generator 650 is usually required in combination with the DC/DC converter 630 in order to regulate the LED current flow. Optionally, a pulse width modulation (PWM) circuit 640 may be implemented to control the light intensity of the LED light bulb unit 100 by voltage modulation. The supporting device unit 600 is coupled to the LED light bulb unit 100, formed by at least one of LED devices, via node V_{c} and node V_{d}.

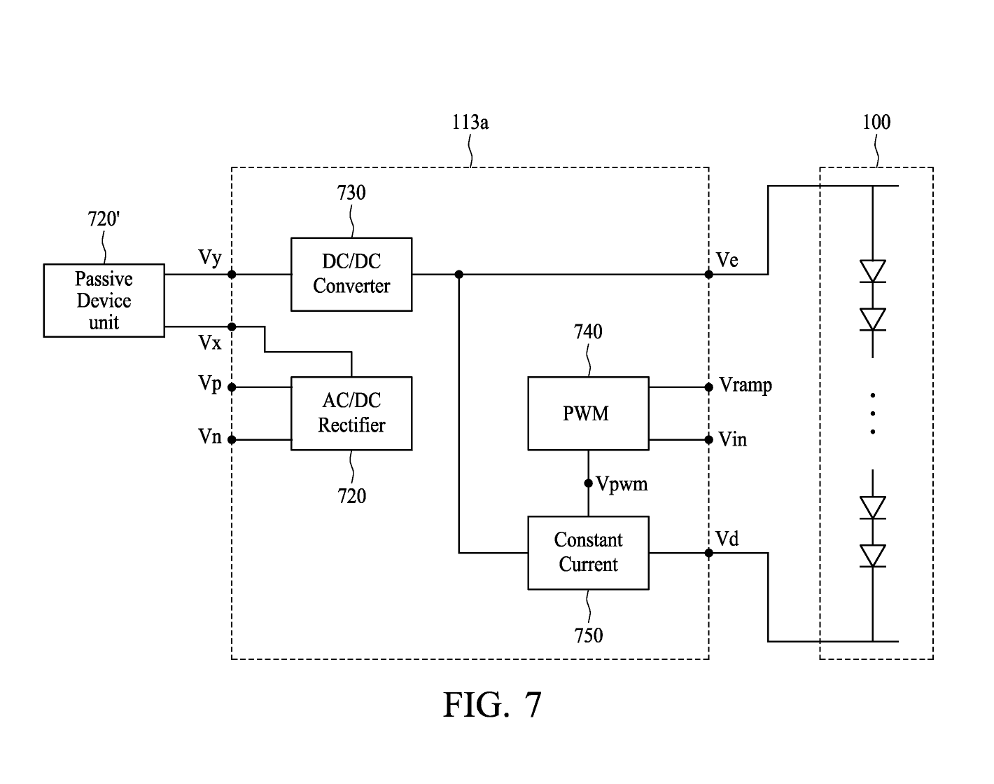

Due to the fact that the lifetime of passive devices, such as discrete, low-cost, large-sized capacitor, is shorter than that of other active devices in the IC, low lifetime devices are separated from its regular IC counterpart in one present embodiment. Once these passive devices fail, users may optionally replace the failing portion without surrendering the entire LED supporting device unit. There is another example of a supporting device circuit as shown in FIG. 7, where the AC/DC rectifier components are split into two portions, a passive device unit 720′ and an active device unit 720. Excluding the passive device unit 720′, other IC components are active devices and thus, a power IC device (supporting device) 113a is essentially a combination of active devices which, when under operation, generate more heat than the passive devices, but on the other hand, have a longer lifespan compared to the vulnerable passive devices. The DC/DC converter 730 for example, may be a buck converter. Other types of DC/DC converters may also be used to achieve the same voltage down-conversion with high efficiency. The output of the DC/DC buck converter Vₑ and the output of constant current generator V_{d} are coupled to the first and second terminal of an LED light bulb unit 100.

In FIG. 7, the pulse width modulation (PWM) circuit 740 has an input Vᵢₙ, Vᵣₐₘₚ and an output V_{pwm}. The constant current control circuit 750 has two inputs (Vₑ, V_{pwm}) and an output V_{d}. In this embodiment, two leads Vₑ and V_{d} connect to the two poles of the LED light bulb unit 100, respectively.

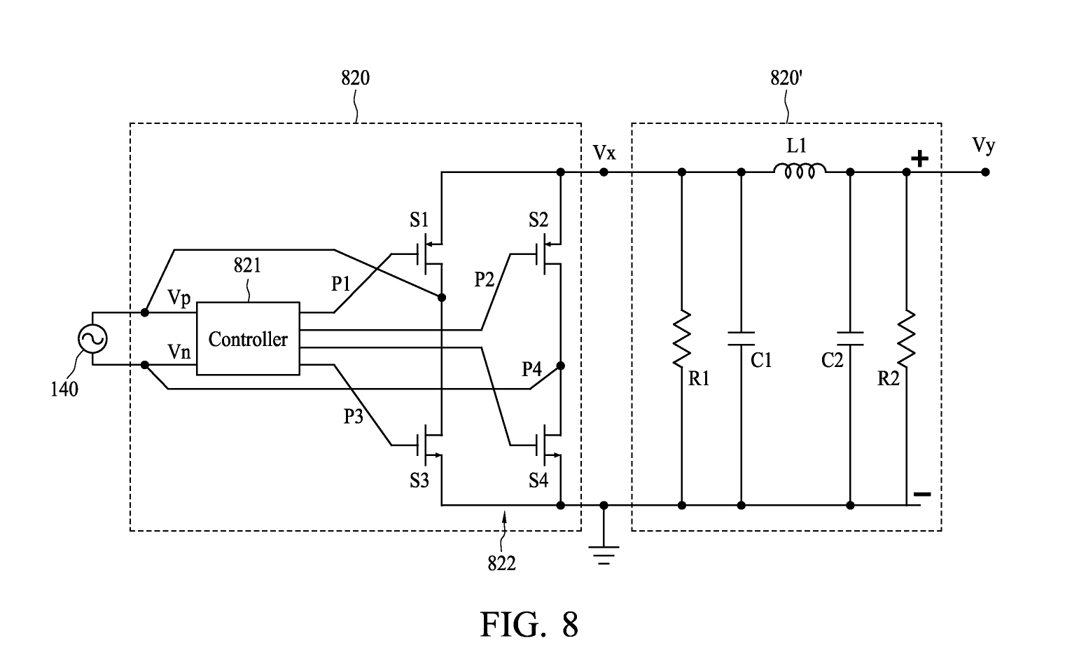

The active device unit 720 and the passive device unit 720′ of the AC/DC rectifier shown in FIG. 7 are enlarged in FIG. 8. In one embodiment, the AC/DC rectifier forms an active block 820 (surrounded by dotted lines) and a passive block 820′ (surrounded by other dotted lines). The active block 820 includes a digital logic controller (or controller) 821 and a bridge circuit 822. This part of the AC/DC rectifier is mostly active devices such as transistors S1-S4. The passive block 820′ is composed of passive and discrete devices such as resistors (R1, R2), capacitors (C1, C2), and inductor L1.

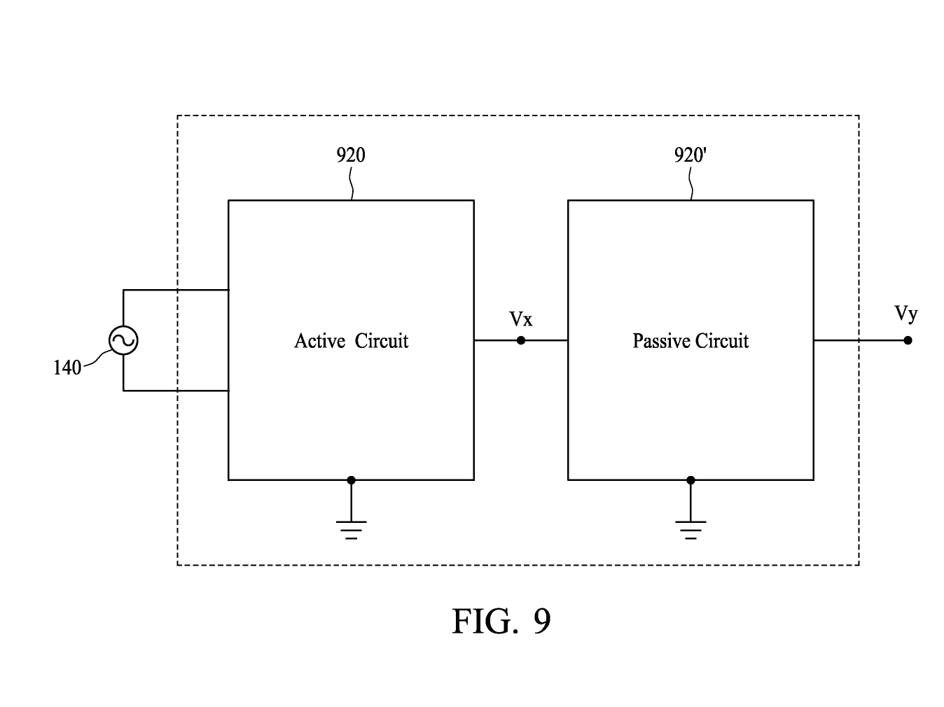

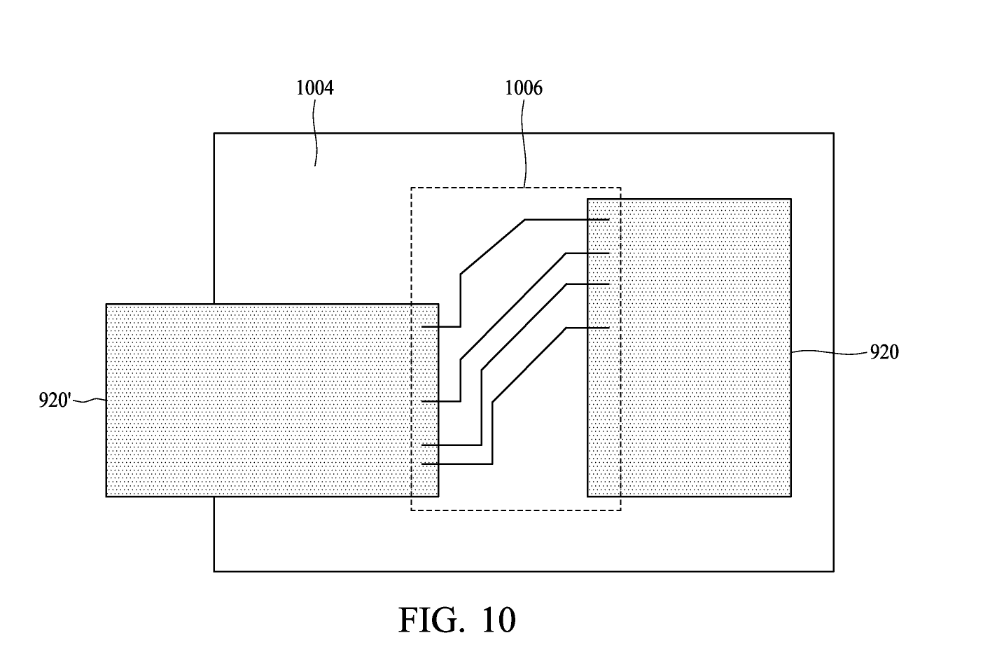

To be more general, the present disclosure provides a separated circuit as shown in FIG. 9. It consists of an active circuit block 920 including active devices configured similarly to that of 820 as shown in FIG.8, and a passive circuit block 920′ having discrete passive components configured similarly to that of 820′ as shown in FIG.8. Both circuit blocks are electrically interconnected via node Vₓ. A power supply 140 is connected to the active circuit block 920 and an output V_{y} is configured to couple to an external load. In one embodiment, ICs having active devices 920 are fabricated on a chip, and those having passive discrete devices 920′ are mounted on a board 1004 as shown in FIG. 10. In another embodiment, integrated passive devices 920′ are mounted on a chip, and that the active devices 920 are mounted on the board. The integrated passive device for example, may be a multi-layer capacitor, a trench capacitor, or a pluggable card built with passive devices. The pluggable card may resemble a universal serial bus (USB) for ease of the replacement process. The interconnections 1006 between the two types of devices (920, 920′) are formed on the board 1004.

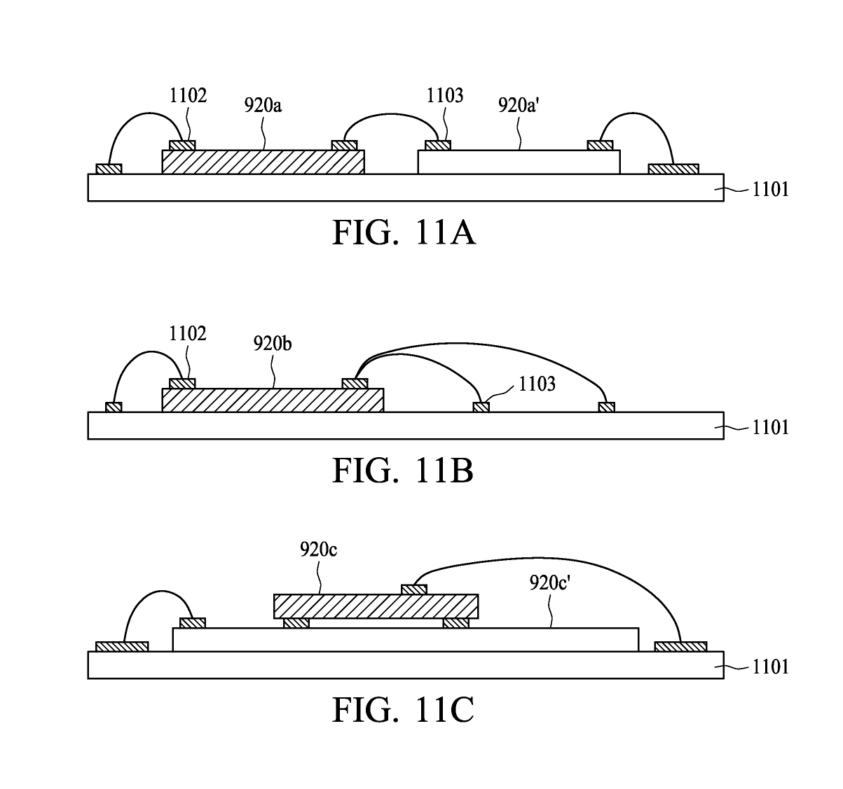

FIGS. 11A to 11C show several alternatives to integrate active and the passive devices on a board in different embodiments. As shown in FIG. 11A, passive devices 1103 are fabricated on a first chip 920a′ and active devices 1102 are fabricated on a second chip 920a. Connections are formed between the board 1101 and the devices (1102, 1103), and across the chips (920a, 920a′). As shown in FIG. 11B, active devices 1102 are integrated on chip 920b while passive devices 1103 are mounted on the board 1101. As shown in FIG. 11C, chips having passive devices (920c) and passive devices (920c′) are stacked on top of each other and mounted on a board 1101.

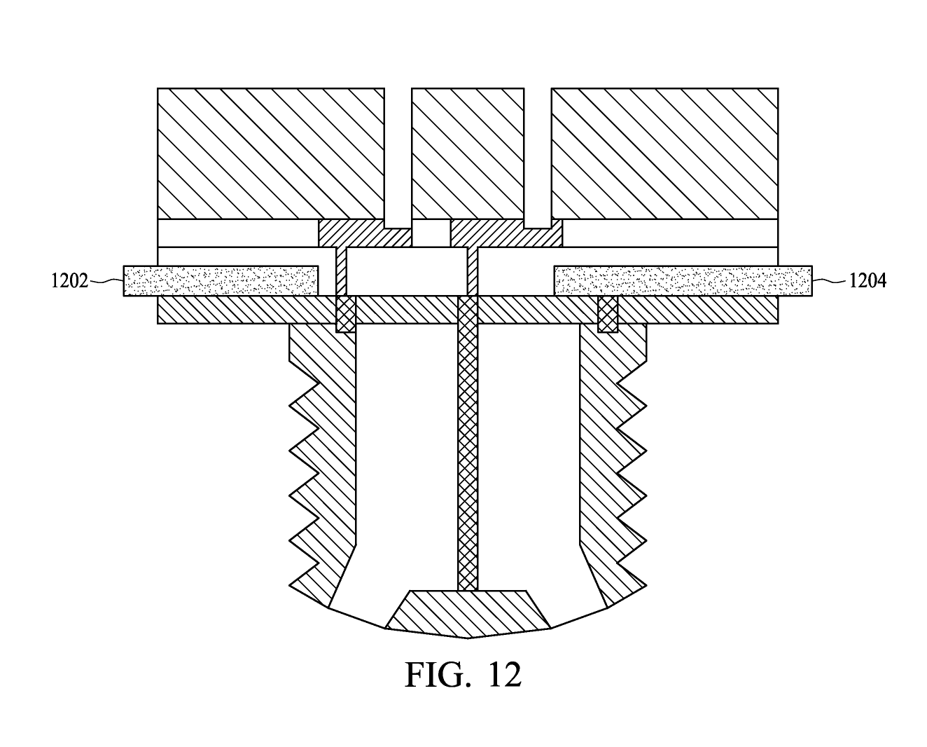

As shown in FIG. 12, in one embodiment, both the active component 1202 and the passive component 1204 of an LED supporting device unit are made replaceable via pluggable design, such as a pluggable card. Once the passive chip 1204 fails, users may pull out the corresponding card and it replace with a functioning one. Similar fashion is applied to the active chip 1202. Therefore, the lifetime of the LED supporting device unit can be further prolonged.

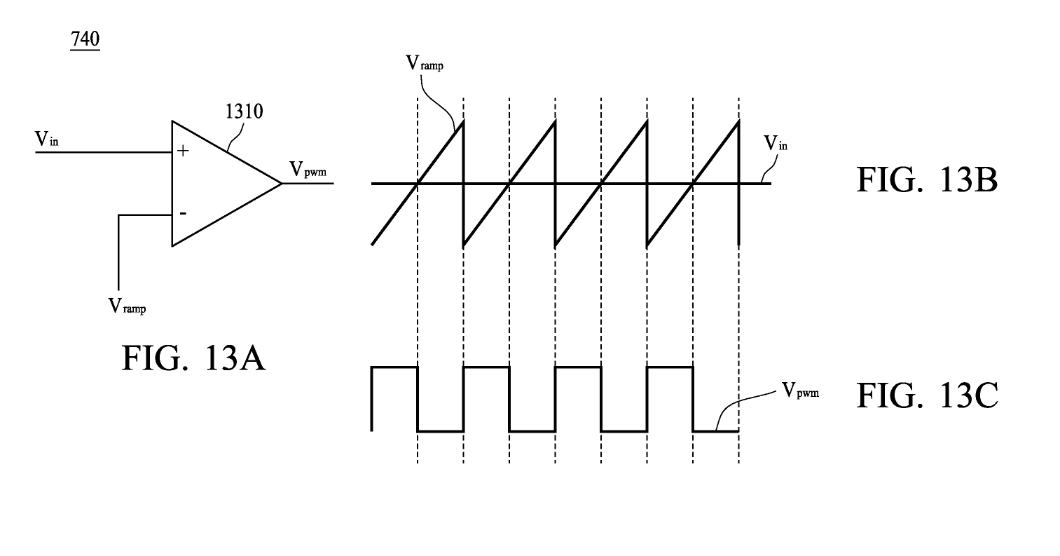

In one embodiment of the present disclosure, light intensity of the LED module can be controlled by a dialing device (not shown). A pulse width modulation (PWM) circuit 740 shown in FIG. 7, is magnified in FIG. 13A. The PWM circuit is basically a differential amplifier 1310. It takes a first input voltage, Vᵣₐₘₚ, which is obtained from a ramp generator (not shown); and a second input voltage, Vᵢₙ, which is obtained from a reference generator (not shown). As shown in FIG. 13B, Vᵣₐₘₚ generates saw-tooth waveforms while Vᵢₙ is a tunable DC reference voltage. By dialing (raising or lowering) the Vᵢₙ level to generate different duty cycles of waveforms as shown in FIG. 13C, one can dim or brighten the light intensity. In other words, the voltage output V_{pwm} of the differential amplifier 1310 shows a waveform of different periodicities according to the level of the DC reference voltage Vᵢₙ. In another embodiment, a conventional on-wall dialing switch or a remote controller can be used to modulate the level of Vᵢₙ to adjust the light intensity of the LED lighting devices. It is also conceivable that the controller can not only dim the light, but also switch the LED light module on or off.

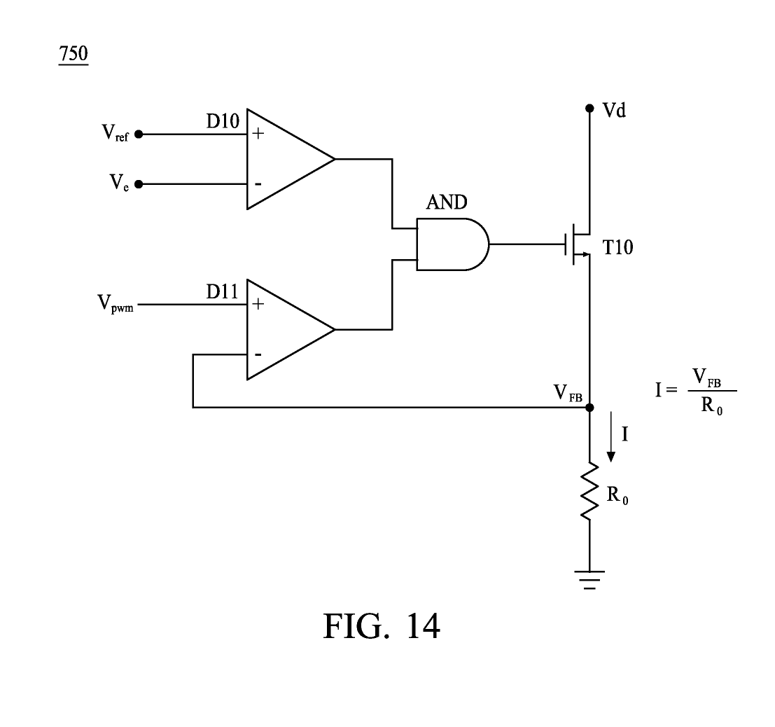

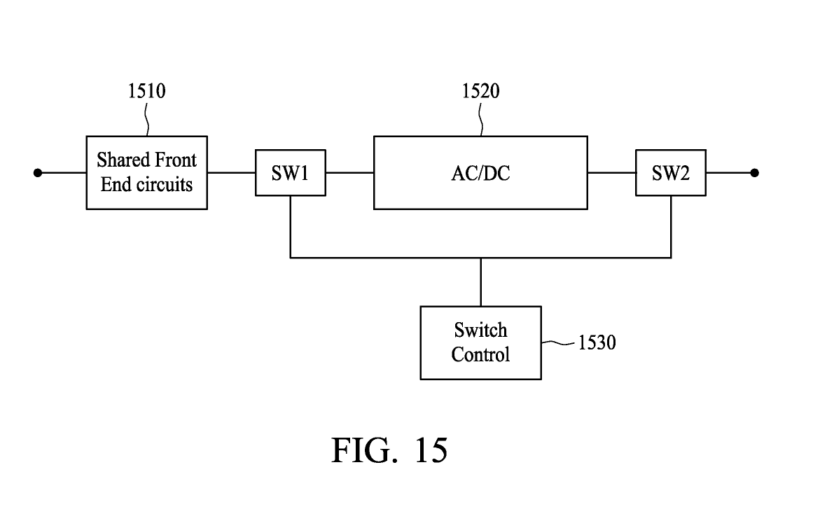

In another embodiment of the present disclosure, a protection mechanism in the power IC is proposed to prevent the LED light bulb module from power surge damages. FIG. 14 shows one embodiment of the constant current generator 750 as illustrated in FIG. 7. The circuit includes a reference voltage (V_{ref}) which is used for over power protection. For example, if V_{ref} is set at 60V, under the normal circumstances that the DC/DC output voltage Vₑ is operated under 48V, but whenever Vₑ reaches or exceeds 60V, the differential amplifier D10 cuts off the current passing through the LED light bulb module by setting the switch T10 to an off state. This arrangement allows hot plugging and avoids sudden power surges.

On the other hand, the signal output from PWM device as shown in FIG. 13, V_{pwm}, is used as the first input of a second differential amplifier D11. A feedback signal V_{FB} from a current monitoring path is used as the second input of D11. The function of D11 is to modulate the current “I” passing through the current monitoring path. The feedback signal V_{FB} will be controlled to be very close to V_{pwm} level. Here, I=V_{FB}/Rₒ, and Rₒ is the effective resistance along the current path. The light intensity of the LED light bulb unit can be adjusted by gradually tuning V_{pwm} to a higher or lower level. The LED light bulb module may be completely dimmed, or turned off, by setting V_{pwm} to be zero. An AND logic receives the output signals from both differential amplifiers D10 and D11, that is, the switch T10 will be on if both signals coming from the amplifiers D10 and D11 are on. In another embodiment, a remote controller may also be used to control the dimming/brightening features via for example, a wireless interface (not shown).

Two commonly used LED light bulbs are DC LED and AC LED. In one embodiment of the present disclosure, one single supporting device unit can be designed to fit for an AC or a DC LED light bulb unit. As shown in FIG. 15, a shared front end circuit 1510 is connected to an AC/DC converter 1520. Switch 1 (SW1) and switch 2 (SW2) are connected respectively in series at the two ends of said converter. In DC mode, the switch controller 1530 will set both SW1 and SW2 to be “short”, while the AC power passing through the shared front end circuits 1510 is allowed to enter the AC/DC converter 1520. Under this situation the supporting device unit is conditioned for a DC LED light bulb module; In AC mode, the switch controller 1530 sets both of the switches SW1 and SW2 to be “open”, as the AC power never enters the AC/DC converter 1520, and therefore the supporting device unit is now supporting an AC LED light bulb module.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A light emitting diode (LED) supporting device unit, comprising:
a body portion comprising at least one LED supporting device;
a heat dissipation structure thermally coupled to the body portion;
a first connector, allowing the at least one LED supporting device to be electrically coupled to an external LED light bulb unit; and
a second connector, allowing the at least one LED supporting device to be electrically coupled to an external power supply.

2. The LED supporting device unit of claim 1, further comprising at least one thermal insulating portion configured to thermally decouple the LED supporting device unit from the external LED light bulb unit coupled to said first connector.

3. The LED supporting device unit of claim 2, the thermal insulating portion is an air space structure fabricated on the LED supporting device unit.

4. The LED supporting device unit of claim 1, wherein the LED supporting device comprises at least one active circuit block and at least one passive circuit block.

5. The LED supporting device unit of claim 4, wherein the active circuit block comprises at least one component of an AC/DC rectifier, a DC/DC converter, a pulse width modulator, a constant current generator, or the combinations thereof.

6. The LED supporting device unit of claim 1, wherein the at least one LED supporting device is configured to provide a switchable AC/DC operation mode.

7. The LED supporting device unit of claim 1, wherein the heat dissipation structure is thermally coupled to said active circuit block.

8. The LED supporting device unit of claim 4, wherein the active circuit block further comprises a power surge protection mechanism configured to prevent current flowing into the coupled LED light bulb unit when the current exceeds a predetermined current level.

9. The LED supporting device unit of claim 4, wherein the active circuit block further comprises a power dimming mechanism configured to adjust light intensity of the coupled LED light bulb unit.

10. The LED supporting device unit of claim 4, wherein at least a portion of the circuit blocks is detachable from the body of the supporting device unit.

11. The LED supporting device unit of claim 4, wherein the passive circuit block is detachable from the body of the supporting device unit.

12. The LED supporting device unit of claim 4, wherein the active circuit block is detachable from the body of the supporting device unit.

13. A light emitting diode (LED) light bulb unit, comprising:
a light bulb body having a cap, at least one base plane and a plurality of LED devices connected in a predetermined manner, wherein the plurality of LED devices are coupled to the at least one base plane inside the cap;
a connector allowing the LED devices to be electrically coupled to an external LED light supporting device unit; and
a heat dissipation structure thermally coupled to the light bulb body to dissipate heat generated by the LED devices.

14. The LED light bulb unit of claim 13, further comprising a thermal insulating portion configured to at least partially thermally decouple the LED light bulb unit and the LED supporting device unit.

15. The LED light bulb unit of claim 14, the thermal insulating portion comprises an air space structure.

16. The LED light bulb unit of claim 13, wherein the predetermined manner of the connection of the plurality of LED devices is to arrange LED devices to receive an AC or DC power supply.

17. The LED light bulb unit of claim 13, wherein the LED devices are positioned at an angle to the at least one base plane.

18. The LED light bulb unit of claim 17, wherein said angle is within a range of from 0 to 90 degrees.

19. A light emitting diode (LED) light bulb module, comprising:
at least one LED light bulb unit comprising a first connector;
an LED supporting device unit coupled to and for supporting said at least one LED light bulb unit and having a second connector, configured to electrically coupled to the first connector, and a third connector configured to electrically coupled to a power supply; and
a thermal insulating portion configured to at least partially thermally decouple the LED light bulb unit and the LED supporting device unit.

20. The LED light bulb module of claim 19, wherein the LED light bulb unit and the LED supporting device unit are detachably associated with each other.

21. The LED light bulb module of claim 19, wherein the LED light bulb unit and the LED supporting device unit are fixedly associated with each other.

22. The LED light bulb module of claim 19, wherein said thermal insulating portion is comprised of: Aerogels, microporous silica, air, wood, ceramic fiber, or the combination thereof.

23. The LED light bulb module of claim 22, wherein the thermal insulating portion is comprised of at least an air space structure.

24. The LED light bulb module of claim 19, wherein the third connector is a detachable connector.

25. The LED light bulb module of claim 24, wherein the detachable connector comprises a screw-type connector, bayonet-type connector, pin-type connector, and the combination thereof.

26. The LED light bulb module of claim 19, wherein the first connector and second connector are coupled by a connector comprises a screw-type connector, bayonet-type connector, pin-type connector, and the combination thereof.

27. The LED module of claim 19, wherein the LED light bulb unit is thermally coupled to a first heat dissipation structure, and wherein the LED supporting device unit is thermally coupled to a second heat dissipation structure.

28. The LED module of claim 27, wherein at least one of the first and the second heat dissipation structures comprise a plurality of fins, a core ring portion and a base plate.

29. The LED module of claim 28, wherein the fins are attached to the core ring portion, base plate, or both.

30. The LED module of claim 27, the first heat dissipation structure having a total heat dissipation surface area which is greater than 60 cm²

31. The LED module of claim 27, the second heat dissipation structure having a total heat dissipation surface area which is greater than 8 cm²
